(19) United States
(12) Patent Application Publication
(10) Pub. No.: US 2023/0362579 A1
(43) Pub. Date: Nov. 9, 2023

(54) SOUND SPATIALIZATION SYSTEM AND METHOD FOR AUGMENTING VISUAL SENSORY RESPONSE WITH SPATIAL AUDIO CUES

(71) Applicant: EmbodyVR, Inc., San Mateo, CA (US)

(72) Inventors: Nikhil JAVERI, San Mateo, CA (US); Marielle Venita JAKOBSONS, Oakland, CA (US); Kapil JAIN, Redwood City, CA (US)

(21) Appl. No.: 17/737,503

(22) Filed: May 5, 2022

(51) Int. Cl. H04S 7/00

(52) U.S. Cl. CPC H04S 7/40; H04S 7/302; H04S 2400/01; H04S 2420/01

(57) ABSTRACT

A method includes receiving an input head-related transfer function (HRTF) and applying a shaping function to the input HRTF to generate a shaped HRTF having a minimum strength at a first point in a three-dimensional space, a maximum strength at a second point in the three-dimensional space, and a gradually increasing strength between the first point and the second point in the three-dimensional space. A system includes a processor and memory storing instructions which when executed by the processor cause the processor to apply a shaping function to an HRTF to generate a shaped HRTF having a minimum strength at a first point in a three-dimensional space, a maximum strength at a second point in the three-dimensional space, and a gradually increasing strength between the first point and the second point in the three-dimensional space.

### CROSS-REFERENCE TO RELATED APPLICATIONS

The application is related to U.S. patent application Ser. No. 16/542,930, filed on Aug. 16, 2019 (now U.S. Pat. No. 10,659,908 issued on May 19, 2020), which is continuation of U.S. patent application Ser. No. 15/811,441, filed on Nov. 13, 2017 (now U.S. Pat. No. 10,433,095 issued on Oct. 1, 2019), which claims priority to U.S. Provisional Application No. 62/468,933, filed on Mar. 8, 2017, U.S. Provisional Application No. 62/466,268, filed on Mar. 2, 2017, U.S. Provisional Application No. 62/424,512, filed on Nov. 20, 2016, U.S. Provisional Application No. 62/421,380, filed on Nov. 14, 2016, and U.S. Provisional Application No. 62/421,285, filed on Nov. 13, 2016. The entire disclosures of the applications referenced above are incorporated herein by reference.

### FIELD

The present disclosure relates to sound spatialization system and method for augmenting visual sensory response with spatial audio cues.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Binauralization using Head-Related Transfer Functions (HRTFs) is extensively used for downmixing spatial audio content for consumption via headphones. Spatialization can be obtained using generic HRTFs. With personalized HRTFs, perception of immersion can be elevated to a higher level. However, due to measurement errors and/or prediction artifacts, generating 100% accurate personalized HRTFs is difficult. Although personalized HRTFs are better than generic HRTFs, tonal coloration occurs due to the prediction/measurement artifacts, which decrease the fidelity of the content being consumed.

### SUMMARY

A method comprises receiving an input head-related transfer function (HRTF); and applying a shaping function to the input HRTF to generate a shaped HRTF having a minimum strength at a first point in a three-dimensional space, a maximum strength at a second point in the three-dimensional space, and a gradually increasing strength between the first point and the second point in the three-dimensional space.

In other features, the method further comprises processing audio component of an audiovisual application using the shaped HRTF; and outputting the processed audio component of the audiovisual application via an output device.

In another feature, the method further comprises aurally augmenting visual sensory cues associated with the audiovisual application based on the gradually increasing strength of the shaped HRTF between the first point and the second point in the three-dimensional space.

In another feature, the shaped HRTF is configured to provide accurate spatial perception throughout the three-dimensional space while providing accurate tonal perception at the first point in the three-dimensional space when audio component of an audiovisual application is output through an output device using the shaped HRTF.

In another feature, the method further comprises generating the shaping function based on at least one of a type of audiovisual content with which the shaped HRTF is to be used, a position of each sound object associated with the audiovisual content, and a type of headphone through which audio component of the audiovisual content is to be output.

In another feature, the method further comprises controlling parameters of the shaping function to control a gradient of the gradually increasing strength of the shaped HRTF between the first point and the second point in the three-dimensional space.

In another feature, the method further comprises controlling parameters of the shaping function based on at least one of a type of audiovisual content with which the shaped HRTF is to be used, a position of each sound object associated with the audiovisual content, and a type of headphone through which audio component of the audiovisual content is to be output.

In another feature, the method further comprises applying an equalizer function to the shaped HRTF to smooth the shaped HRTF and to match loudness between the shaped HRTF and the input HRTF.

In another feature, the method further comprises changing equalization of a headphone through which audio component of an audiovisual content is to be output using the shaped HRTF.

In another feature, the input HRTF is a generic HRTF.

In other features, the method further comprises receiving a graphical representation of a pinna including an image or images, a video, or a 3D scan of the pinna; and generating the input HRTF based on the graphical representation of the pinna.

In still other features, a system comprises a processor; and memory storing instructions which when executed by the processor cause the processor to provide an audiovisual content through a display and an audio output device; select a shaped head-related transfer function (HRTF) based on a type of the audiovisual content; process audio component of the audiovisual content using the selected shaped HRTF; and output the processed audio component through the audio output device. The selected shaped HRTF is configured to provide accurate spatial perception throughout a three-dimensional space surrounding a listener of the processed audio component while providing accurate tonal perception in front of the listener in the three-dimensional space.

In another feature, the shaped HRTF has a minimum strength in front of the listener in the three-dimensional space, a maximum strength at the back of the listener in the three-dimensional space, and a gradually increasing strength between the front and the back of the listener in the three-dimensional space.

In another feature, the shaped HRTF aurally augments visual sensory cues associated with the audiovisual content based on a gradually increasing strength of the shaped HRTF between the front and the back of the listener in the three-dimensional space.

In another feature, the shaped HRTF is smoothed by applying an equalizer function to the shaped HRTF.

In another feature, the instructions cause the processor to change equalization of the audio output device.

In other features, the instructions cause the processor to generate the shaped HRTF by applying a shaping function to an input HRTF, and parameters of the shaping function are controlled to control a gradient of strength of the shaped HRTF between the front and the back of the listener in the three-dimensional space.

In another feature, the instructions cause the processor to control the parameters of the shaping function based on at least one of the type of the audiovisual content, a position of the audio output device, and a type of the audio output device.

In another feature, the instructions cause the processor to apply an equalizer function to the shaped HRTF to smooth the shaped HRTF and to match loudness between the shaped HRTF and the input HRTF.

In another feature, the input HRTF is a generic HRTF.

In other features, the instructions cause the processor to receive a graphical representation of a pinna of the listener including an image or images, a video, or a 3D scan of the pinna; and generate the input HRTF based on the graphical representation of the pinna of the listener.

In other features, the instructions cause the processor to send a graphical representation of a pinna of the listener to a remote server, the graphical representation including an image or images, a video, or a 3D scan of the pinna; and receive from the remote server the input HRTF generated by the remote server based on the graphical representation of the pinna of the listener.

In other features, the instructions cause the processor to send a graphical representation of a pinna of the listener to a remote server, the graphical representation including an image or images, a video, or a 3D scan of the pinna; and receive the shaped HRTF from the remote server.

In other features, the instructions cause the processor to send the type of the audiovisual content to the remote server; and receive from the remote server the shaped HRTF generated by the remote server based on the type of the audiovisual content.

In other features, the instructions cause the processor to provide a graphical user interface (GUI) on the display; receive a plurality of shaped HRTFs from a remote server; receive inputs from the listener via the GUI, the inputs including at least one of the type of the audiovisual content, a position of the audio output device, and a type of the audio output device; and select the shaped HRTF from the plurality of shaped HRTFs based on the inputs.

In still other features, a system comprises a processor; and memory storing instructions which when executed by the processor cause the processor to apply a shaping function to an HRTF to generate a shaped HRTF having a minimum strength at a first point in a three-dimensional space, a maximum strength at a second point in the three-dimensional space, and a gradually increasing strength between the first point and the second point in the three-dimensional space.

In another feature, the shaped HRTF is configured to provide accurate spatial perception throughout the three-dimensional space while providing accurate tonal perception at the first point in the three-dimensional space when audio component of an audiovisual application is output through an output device using the shaped HRTF.

In another feature, when audio component of an audiovisual application is output through an output device using the shaped HRTF, the shaped HRTF is configured to aurally augment visual sensory cues based on the gradually increasing strength of the shaped HRTF between the first point and the second point in the three-dimensional space.

In another feature, the instructions cause the processor to generate the shaping function based on at least one of a type of audiovisual content with which the shaped HRTF is to be used, a position of each sound object associated with the audiovisual content, and a type of headphone through which audio component of the audiovisual content is to be output.

In another feature, the instructions cause the processor to control parameters of the shaping function to control a gradient of the gradually increasing strength of the shaped HRTF between the first point and the second point in the three-dimensional space.

In another feature, the instructions cause the processor to control parameters of the shaping function based on at least one of a type of audiovisual content with which the shaped HRTF is to be used, a position of each sound object associated with the audiovisual content, and a type of headphone through which audio component of the audiovisual content is to be output.

In another feature, the instructions cause the processor to apply an equalizer function to the shaped HRTF to smooth the shaped HRTF and to match loudness between the shaped HRTF and the HRTF.

In another feature, the HRTF is a generic HRTF.

In other features, the instructions cause the processor to receive a graphical representation of a pinna including an image or images, a video, or a 3D scan of the pinna; and generate the HRTF based on the graphical representation of the pinna.

In other features, the system further comprises a user device configured to access the shaped HRTF; process audio component of an audiovisual application using the shaped HRTF; and output the processed audio component of the audiovisual application via an output device.

In another feature, the user device is configured to change equalization of a headphone through which audio component of an audiovisual content is to be output using the shaped HRTF.

In other features, the system further comprises a user device configured to download the shaped HRTF; process audio component of an audiovisual application using the shaped HRTF; and output the processed audio component of the audiovisual application via an output device.

In another feature, the user device is configured to change equalization of a headphone through which audio component of an audiovisual content is to be output using the shaped HRTF.

In other features, the system further comprises a user device configured to provide a graphical user interface (GUI) on a display of the user device; receive a plurality of the shaped HRTF; receive inputs from a user via the GUI, the inputs including at least one of a type of an audiovisual content provided on the user device, a position of each sound object associated with the audiovisual content, and a type of a headphone to be used with the user device; and select the shaped HRTF based on the inputs.

In other features, the system further comprises a user device configured to process audio component of an audiovisual application using the shaped HRTF; and output the processed audio component of the audiovisual application via an output device.

In another feature, the shaped HRTF is configured to aurally augment visual sensory cues associated with the audiovisual application based on the gradually increasing strength of the shaped HRTF between the first point and the second point in the three-dimensional space.

In still other features, a non-transitory computer-readable medium storing a computer program comprising instructions which when executed by a processor cause the processor to receive an input head-related transfer function (HRTF); and apply a shaping function to the input HRTF to generate a shaped HRTF having a minimum strength at a first point in a three-dimensional space, a maximum strength at a second point in the three-dimensional space, and a gradually increasing strength between the first point and the second point in the three-dimensional space.

In other features, the instructions cause the processor to process audio component of an audiovisual application using the shaped HRTF; and outputting the processed audio component of the audiovisual application via an output device.

In another feature, the instructions cause the processor to aurally augment visual sensory cues associated with the audiovisual application based on the gradually increasing strength of the shaped HRTF between the first point and the second point in the three-dimensional space.

In another feature, the shaped HRTF is configured to provide accurate spatial perception throughout the three-dimensional space while providing accurate tonal perception at the first point in the three-dimensional space when audio component of an audiovisual application is output through an output device using the shaped HRTF.

In another feature, the instructions cause the processor to generate the shaping function based on at least one of a type of audiovisual content with which the shaped HRTF is to be used, a position of each sound object associated with the audiovisual content, and a type of headphone through which audio component of the audiovisual content is to be output.

In another feature, the instructions cause the processor to control parameters of the shaping function to control a gradient of the gradually increasing strength of the shaped HRTF between the first point and the second point in the three-dimensional space.

In another feature, the instructions cause the processor to control parameters of the shaping function based on at least one of a type of audiovisual content with which the shaped HRTF is to be used, a position of each sound object associated with the audiovisual content, and a type of headphone through which audio component of the audiovisual content is to be output.

In another feature, the instructions cause the processor to apply an equalizer function to the shaped HRTF to smooth the shaped HRTF and to match loudness between the shaped HRTF and the input HRTF.

In another feature, the instructions cause the processor to change equalization of a headphone through which audio component of an audiovisual content is to be output using the shaped HRTF.

In another feature, the input HRTF is a generic HRTF.

In other features, the instructions cause the processor to receive a graphical representation of a pinna including an image or images, a video, or a 3D scan of the pinna; and generate the input HRTF based on the graphical representation of the pinna.

In other features, the instructions cause the processor to send a graphical representation of a pinna to a remote server including an image or images, a video, or a 3D scan of the pinna; and receive from the remote server the input HRTF generated by the remote server based on the graphical representation of the pinna.

In other features, the instructions cause the processor to send a type of an audiovisual content to the remote server; and receive from the remote server the shaped HRTF generated by the remote server based on the type of the audiovisual content.

55 In other features, the instructions cause the processor to provide a graphical user interface (GUI) on a display of a user device; receive a plurality of the shaped HRTF from a remote server; receive inputs via the GUI, the inputs including at least one of a type of an audiovisual content, a position of each sound object associated with the audiovisual content, and a type of headphone to be used with the user device; and select the shaped HRTF from the plurality of shaped HRTFs based on the inputs.

In other features, the instructions cause the processor to access the shaped HRTF; process audio component of an audiovisual application using the shaped HRTF; and output the processed audio component of the audiovisual application via an output device.

In another feature, the instructions cause the processor to change equalization of a headphone through which audio component of an audiovisual content is to be output using the shaped HRTF.

In other features, the instructions cause the processor to download the shaped HRTF; process audio component of an audiovisual application using the shaped HRTF; and output the processed audio component of the audiovisual application via an output device.

In another feature, the instructions cause the processor to change equalization of a headphone through which audio component of an audiovisual content is to be output using the shaped HRTF.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a distributed computing system comprising servers and client devices for generating shaped head-related transfer functions (HRTFs) and using the shaped HRTFs for consuming content according to the present disclosure;

FIG. 2 shows an example of a client device of FIG. 1;

FIG. 3 shows an example of a server of FIG. 1;

FIG. 4 shows an overview of a method of generating shaped HRTFs according to the present disclosure;

FIG. 5 shows operations performed by a shaping function used in the method of FIG. 4 when generating the shaped HRTF according to the present disclosure;

FIG. 6 shows a method performed by the shaped HRTF when a user consumes content using the shaped HRTF according to the present disclosure;

FIG. 7 shows a method of applying the shaping function to an HRTF to generate the shaped HRTF in further detail;

FIG. 8 shows a method of generating libraries of shaped HRTFs according to the present disclosure;

FIG. 9 is a graph showing examples of unshaped and shaped HRTFs illustrating % strength of HRTF relative to angle in degrees;

FIGS. 10-14 show graphs of unshaped and shaped HRTFs at a selected angle with shaped HRTFs generated using different strengths of the shaping function; and

FIGS. 15-20 show graphs of unshaped and shaped HRTFs at different angles and varying strength of the shaping function.

In the drawings, reference numbers may be reused to identify similar and/or identical elements.

### DETAILED DESCRIPTION

The present disclosure provides a system and method for shaping of a head-related transfer function (HRTF) along spatial axes such that tonal coloration, perceived and otherwise, reduces in front of the subject (listener) while sufficient spatialization is maintained all around the subject. The shaping of the HRTF is performed by changing characteristics of the HRTF such that the out-of-head listening experience for sound objects in front of the subject is better aligned with the visual cues by reducing the effect of the HRTF in the front while still maintaining tonal connectivity and delay with the rest of the space. A sound object can be any item in the content being consumed by the user that can emit sound. For example, a sound object can be a helicopter flying overhead in a game, a person talking in a movie, and so on. In general, any object to which sound can be attached can be classified as a sound object in an audiovisual content, and each sound object has a position in 3D space.

Specifically, the present disclosure provides a system and method for creating a clearer, more transparent, shaped HRTF than generic and personalized HRTFs. The system provides a shaped HRTF with which auditory sensory response augments the visual sensory response of the subject including an experience such that the subject's peripheral and blind vision spots are aided and augmented aurally by the spatializing quality of the shaped HRTF. The shaped HRTF is reduced in strength in the front and gradually returns to normal strength behind the subject's head.

A shaping function is applied to an HRTF that is either predicted or measured on a spherical surface. The shaping function controls relative effect of the HRTF in the front versus the back of the head. The shaping function adjusts the strength of the HRTF such that minima is/are right in front of the subject and maxima is exactly behind the subject. The HRTF transition between the minima and the maxima is smooth (gradual), and the gradient of the transition is controlled by the shaping function's parameters.

The original input HRTF (generic or personalized based on a graphical representation of the user's pinna including an image or images, a video, or a 3D scan of the pinna) is operated upon with the shaping function to create the shaped HRTF. The shaping function is parametric and is based on the input HRTF and the specific grid point, which is a combination of azimuth, elevation, and distance of the specific grid point in 3D space at which the shaping function is applied. The shaping of the input HRTF involves processing the input HRTF such that the shaped HRTF, perceptually and otherwise, attempts to match the tone of the content in the front without losing out on the directionality. The shaping of the input HRTF involves processing the input HRTF such that the shaped HRTF, perceptually and otherwise, attempts to bring the sound field close to the subject's face in the front and pushes it away behind the subject's face. The shaping of the input HRTF involves controlling parameters of the shaping function that are dependent upon the content type, the position of a sound object in the content relative to the user, head position of the user, and so on.

Typically, HRTFs are used to downmix/binauralize content from a plurality of audio sources. Generic HRTFs perform well and give a sense of spatialization, albeit not accurately. Personalized HRTFs take this experience to a higher level by eliminating front-back, back-front, and tonal confusions. However, measuring a personalized HRTF is difficult and time consuming, and predicting the personalized HRTF may not be 100% accurate. In such a scenario, processing the HRTF according to the present disclosure such that it yields a perceptually augmented HRTF (i.e., the shaped HRTF) improves immersion experience.

In applications that have visual cues like video content on a screen, auditory cues coming in from the front of the user do not necessarily need spatialization. Auditory cues that map to the peripheral and blind vision (space behind ears) are more important than the ones that a subject can see. In such scenarios, giving more transparency to frontal sound representations can be beneficial along with spatializing areas around the sides and back of the head. Using the shaping methods described above, HRTFs can be shaped in any given pattern as desired.

The shaping solves two problems: First, the tonal imbalance that arises due to mismatching real versus measured/predicted HRTFs in the front of the subject (front tone tolerances are much less compared to the rear) is reduced because the shaped HRTF strength is reduced in the front. Second, the strength of the shaped HRTF is gradually increased while moving away from the front-center towards the rear, which leads to accurate spatial perception all around the subject along with a clearer tonal perception in the front.

In use, the user uploads a graphical representation of the user's pinna (including an image or images, a video, or a 3D scan of the pinna) to a server in a cloud along with the type of content being consumed by the user. The server generates a library of shaped HRTFs. The library is then referenced by an application (i.e., a software program or program product generated according to the present disclosure) on the user's device used to consume the content. The library may be referenced from the server in the cloud or may be downloaded on the user's device and then referenced locally. Alternatively, the library may also be generated on the user device using the application. That is, the shaping of the HRTFs can be performed using the application on the user device instead of on the server in the cloud. Subsequently, based on the type of content and other parameters set by the user on the application, the application selects the shaped HRTFs from the library that are suitable for the content being consumed by the user.

Further, the application, whether referencing libraries of shaped HRTFs on a remote server or generating the shaped HRTFs on the user device, can operate in conjunction with the content delivering applications (e.g., video games). Alternatively, the application can be interfaced or integrated with (e.g., built into) the content delivering application (e.g., video games). Furthermore, in some implementations, the generation of personalized HRTFs can be offloaded to the server in the cloud, and the shaping of the personalized HRTFs can be performed by the application on the user device. Accordingly, the functionalities involved in generating the shaped HRTFs can be distributed between the server and the user device, or can be performed on the user device with or without relying on the server. These and other features of the present disclosure are described below in detail.

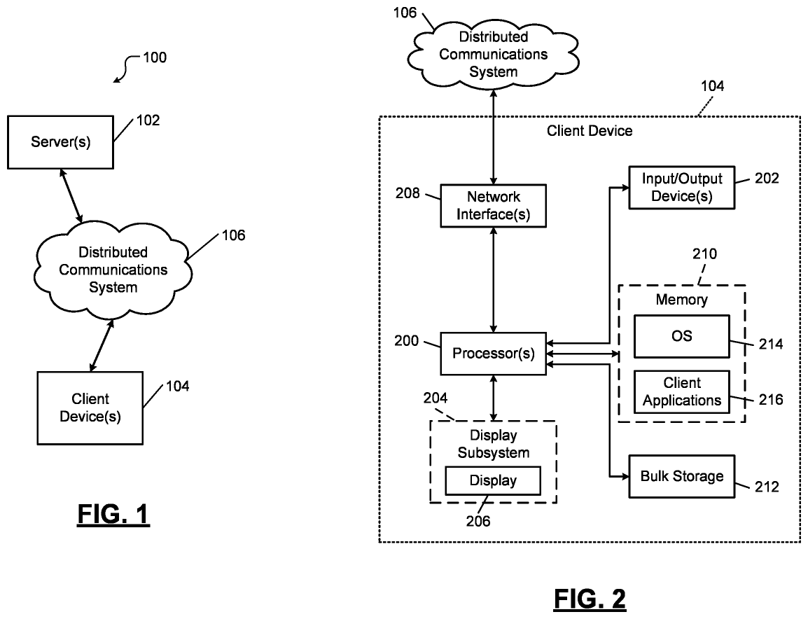

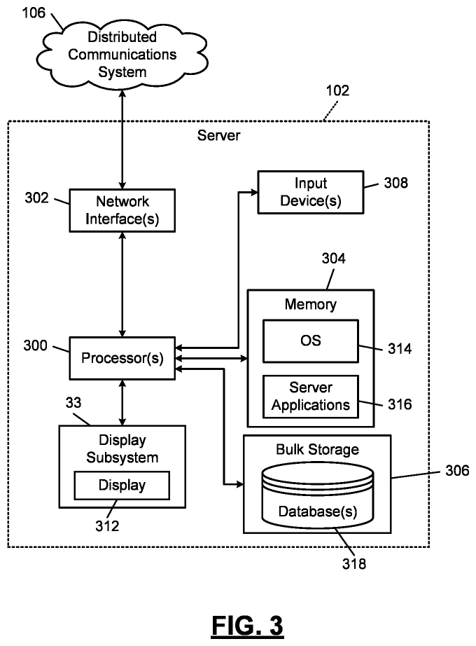

FIGS. 1-3 show an environment in which the system and method of the present disclosure can be implemented. FIG. 1 shows a simplified example of a distributed computing system comprising one or more servers and one or more user devices called client devices. FIG. 2 shows a simplified example of a client device. FIG. 3 shows a simplified example of a server.

FIG. 1 shows a distributed computing system 100 for generating shaped HRTFs and using the shaped HRTFs for consuming content according to the present disclosure. The system 100 comprises one or more servers 102 and one or more client devices 104. The one or more servers 102 (called the server 102 or the servers 102) and the one or more client devices 104 (called the client device 104 or the client devices 104) communicate via a network 106. The network 106 may comprise a distributed communications system such as a local area network (LAN), a wide area network (WAN), and/or the Internet.

The client device 104 is explained in detail with reference to FIG. 2. Briefly, the client device 104 can include any computing device suitable for consuming any audiovisual content such as video games, movies, and so on. Non-limiting examples of the client device 104 include a gaming device, a smartphone, or any portable or handheld computing device capable of providing audiovisual content to the user. The client device 104 executes an application that provides the audiovisual content. The client device 104 communicates with the server 102 via the network 106. The client device 104 uploads a graphical representation of the user's pinna including an image or images, a video, or a 3D scan of the pinna and other data (e.g., content type etc.) to the server 102. The server 102 generates shaped HRTFs based on the graphical representation and the other data. The application on the client device 104 selects suitable shaped HRTFs and provides the audiovisual content to the user on the client device 104 using the selected shaped HRTFs.

Alternatively, the client device 104 executes an application that generates and/or shapes HRTFs according to the present disclosure as explained below in detail. The application on the client device 104 can be standalone or can be integrated with the application that provides the audiovisual content (e.g., a video game). Hereinafter, the application that provides the audiovisual content is called the content application, and the application that generates and/or shapes the HRTFs according to the present disclosure is called the shaping application. In some implementations, the content application and the shaping application can be integrated into a single application.

In some examples, a first portion of the shaping application can reside on the server 102 and a second portion of the shaping application can reside on the client device 104. For example, the first portion on the server 102 may create libraries of shaped HRTFs and the second portion on the client device 104 may reference the libraries from the server 102. Alternatively, the second portion on the client device 104 may download the libraries from the server 102 and then reference the downloaded libraries. In other examples, the first portion on the server 102 may only generate personalized HRTFs based on the graphical representation of the pinna and the second portion on the client device 104 may shape the HRTFs, create libraries of shaped HRTFs, and reference the libraries. In still other examples, the first and second portions may reside on the client device 104, and may generate personalized HRTFs and shaped HRTFs on the client device 104. These features are explained below in detail.

The server 102 generates libraries of shaped HRTFs for various types of content (e.g., various video games) and various users based on the graphical representations of their pinnae and the types of audiovisual content being consumed by the users as described below in detail. The client device 104 can download or access the libraries from the server 102 via the network 106. For example, the libraries can be distributed from the server 102 to the client devices 104 via the network 106 as software-as-a-service (SaaS).

FIG. 2 shows a simplified example of the client device 104. The client device 104 may typically include one or more central processing unit (CPU), one or more graphical processing unit (GPU), and one or more tensor processing unit (TPU) (collectively shown as processor(s) 200), one or more input/output devices 202 (e.g., a keypad, touchpad, mouse, touchscreen, detectors or sensors such as cameras, speakers, headphones, etc.), a display subsystem 204 including a display 206, a network interface 208, memory 210, and bulk storage 212.

The network interface 208 connects the client device 104 to the server 102 via the network 106. For example, the network interface 208 may include a wired interface (e, an Ethernet, EtherCAT, or RS-485 interface) and/or a wireless interface (e.g., Wi-Fi, Bluetooth, near field communication (NFC), or other wireless interface). The memory 210 may include volatile or nonvolatile memory, cache, or other type of memory. The bulk storage 212 may include flash memory, a magnetic hard disk drive (HDD), and other bulk storage devices.

The processor 200 of the client device 104 executes an operating system (OS) 214 and one or more client applications 216. The client applications 216 include an application that accesses the server 102 via the network 106. The client applications 216 include one or more content applications for providing audiovisual content to the user of the client device 104 via the input/output devices 202 and the display subsystem 204. The client applications 216 include the shaping application that can generate shaped HRTFs or that can download or access libraries of shaped HRTFs from the server 102 via the network 106.

FIG. 3 shows a simplified example of the server 102. The server 102 typically includes one or more CPUs/GPUs/TPUs or processors 300, a network interface 302, memory 304, and bulk storage 306. In some implementations, the server 102 may be a general-purpose server and may include one or more input devices 308 (e.g., a keypad, touchpad, mouse, etc.) and a display subsystem 310 including a display 312.

The network interface 302 connects the server 102 to the network 106. For example, the network interface 302 may include a wired interface (e.g., an Ethernet or EtherCAT interface) and/or a wireless interface (e.g., a Wi-Fi, Bluetooth, near field communication (NFC), or other wireless interface). The memory 304 may include volatile or nonvolatile memory, cache, or other type of memory. The bulk storage 306 may include flash memory, one or more magnetic hard disk drives (HDDs), or other bulk storage devices.

The processor 300 of the server 102 executes one or more operating system (OS) 314 and one or more server applications 316, which may be housed in a virtual machine hypervisor or containerized architecture with shared memory. The bulk storage 306 may store one or more databases 318 that store data structures used by the server applications 316 to perform respective functions. The server applications 316 include the shaping application that generates libraries of shaped HRTFs from generic or personalized HRTFs. The server applications 316 also include applications that generate personalized HRTFs.

FIG. 4 shows an overview of a method 400 for generating shaped HRTFs according to the present disclosure. For example, the method 400 can be performed on the server 102, on the client device 104, or partly on each of the server 102 and the client device 104. For example, the method 400 can be implemented as the shaping application in the form of a program product.

At 402, the method 400 receives a graphical representation of a pinna (e.g., an image or images, a video, and/or a 3D scan of the pinna) of the user of the client device 104. For example, the client device 104 may capture the graphical representation or may receive the graphical representation from a source external to the client device 104 (e.g., from a camera, a photo library, etc.).

At 404, the method 400 generates a shaping function based on inputs received from the user of the client device 104. For example, the shaping application on the client device 104 may provide a graphical user interface (GUI). Using the GUI, the user may input parameters. For example, the parameters may include type of content (e.g., a video game) being consumed by the user, position of each sound object associated with the audiovisual content, type of headphones through which the user will hear the audio output of the content, etc.

At 406, the method 400 applies the shaping function to a first HRTF (generic or personalized HRTF generated based on the graphical representation of the pinna) to generate a second HRTF. At 408, the method 400 applies an equalizer or a filter to the second HRTF to generate the shaped HRTF that the user can use with the content to be consumed. The shaping function and generation of the shaped HRTF are described below in further detail.

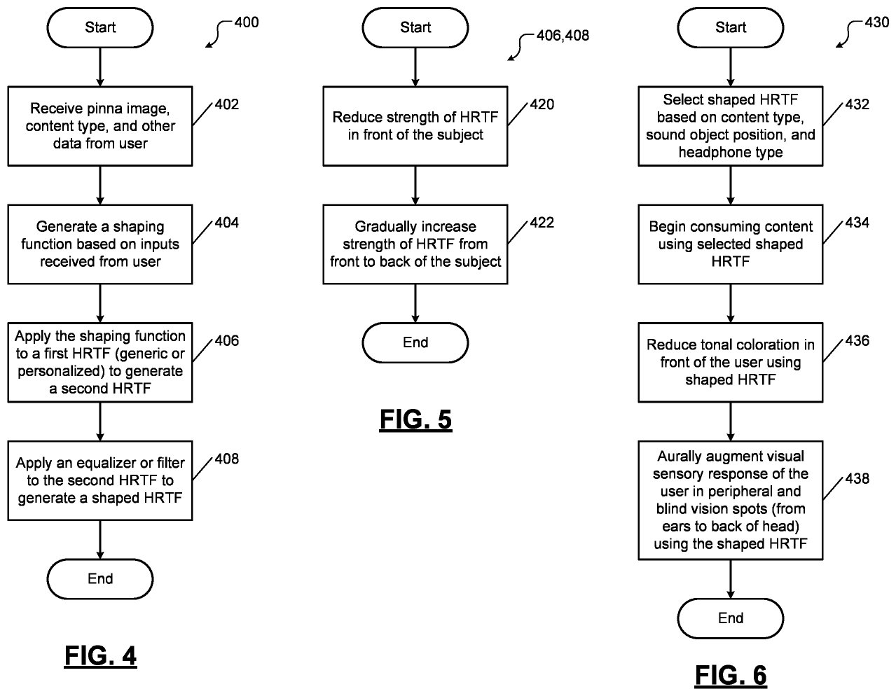

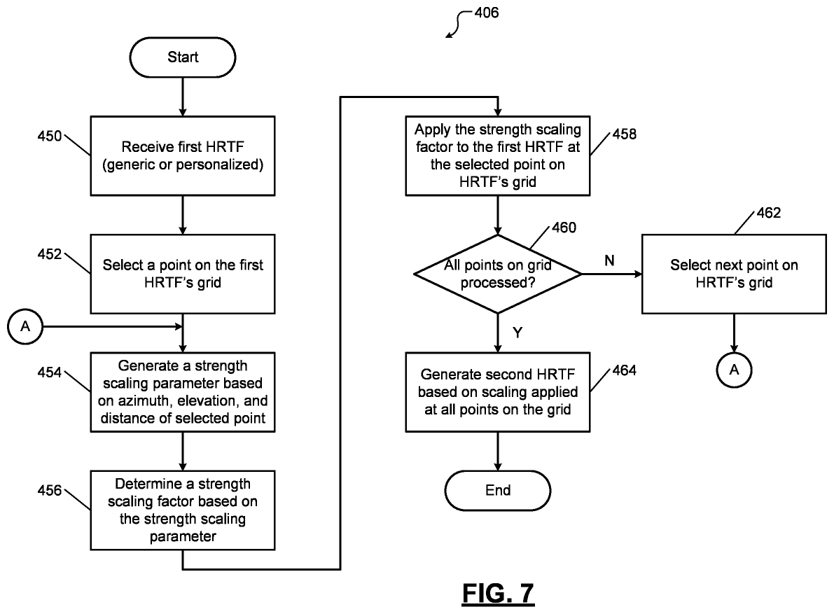

FIG. 5 shows steps 406 and 408 of the method 400 in terms of the operations performed by the shaping function when generating the shaped HRTF according to the present disclosure. At 420, the shaping function reduces the strength of the first HRTF (generic or personalized) in the front of the subject (i.e., the user). At 422, the shaping function gradually increases the strength of the first HRTF (generic or personalized) from front to back of the subject (i.e., the user). Thus, the strength of the shaped HRTF is reduced in the front of the subject and is gradually increased to the back of the user's head to a maxima at the back of the user's head.

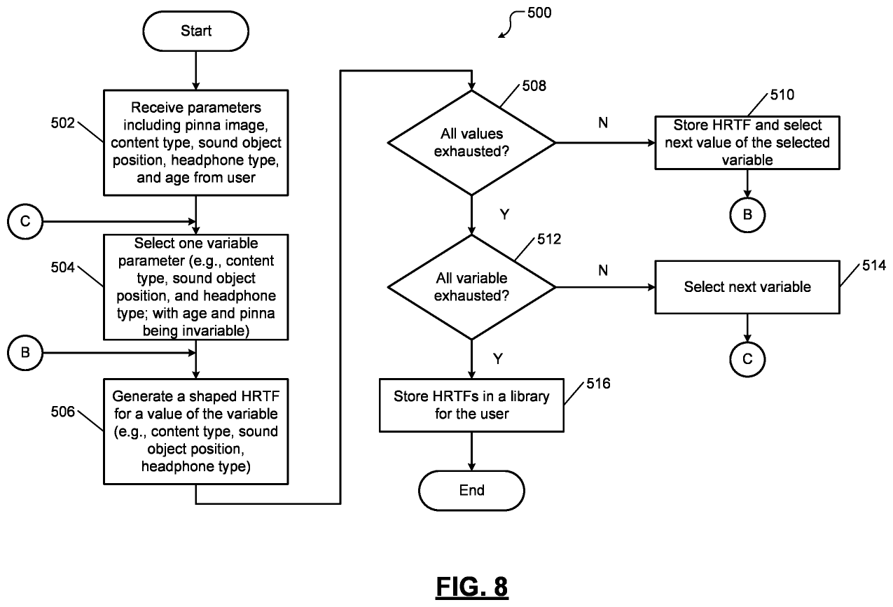

FIG. 6 shows a method 430 performed by the shaped HRTF when the user consumes the content using the shaped HRTF according to the present disclosure. The method 430 can be implemented with the method 400 as an integrated program product or can be implemented as a separate program product that operates in conjunction with the program product implementing the method 400.

At 432, the user selects the shaped HRTF based on parameters such as content type (e.g., video game), the position of the sound object in the content, or associated with the audiovisual content, the headphone type through which the audio portion of the audiovisual content is to be consumed, head position of the user, etc. For example, the user may enter these parameters using the GUI provided by the shaping application on the client device 104. In some examples, when the shaping application is integrated with the content application, the shaping application may already know the content type, and the user may enter other parameters using the GUI. The shaping application selects the shaped HRTF to use with the content type based on these parameters.

At 434, the method 430 begins consuming the content (e.g., the user begins playing a video game on the client device 104) using the shaped HRTF. At 436, the method 430 (i.e., the shaped HRTF) reduces the tonal coloration in front of the user using the shaped HRTF. At 438, the method 430 (i.e., the shaped HRTF) aurally augments visual sensory response of the user in peripheral and blind vision spots (from ears to back of the head) of the user using the shaped HRTF.

FIG. 7 shows step 406 of the method 400 (i.e., a method of applying the shaping function to the first HRTF to generate the shaped HRTF) in further detail. Again, the following steps may be performed partially or entirely on the server 102 or on the client device 104. At 450, the method 400 receives the first HRTF (generic or personalized). For example, the client device 104 may send the graphical representation of the pinna of the user from the client device 104 to the server 102, and may receive a personalized HRTF generated based on the graphical representation of the pinna from the server 102. Alternatively, the client device 104 may receive a generic HRTF from the server 102. In other examples, the client device 104 may use a generic HRTF stored on the client device 104 or may generate the personalized HRTF based on the graphical representation of the pinna on the client device 104.

At 452, the method 400 selects a point on a spherical grid of the first HRTF. At 454, the method 400 generates a strength scaling parameter (explained below) based on the azimuth, elevation, and distance of the selected point on the grid. At 456, the method 400 determines a strength scaling factor based on the strength scaling parameter as explained below in detail. At 458, the method 400 applies the strength scaling factor to the first HRTF at the selected point on the grid.

At 460, the method 400 determines if all point on the grid are processed as described above in steps 454, 456, and 458. If some points on the grid remain to be processed, at 462, the method 400 selects the next point on the grid, and the method 400 returns to step 454 and repeats steps 454, 456, and 458 for the next point on the grid. The method 400 repeats steps 454, 456, and 458 for all points on the grid. When all points on the grid are processed as described above, at 464, the method 400 generates the second HRTF based on the scaling applied at all points on the grid.

An example of the strength scaling (i.e., shaping) of the first HRTF (generic or personalized) performed by the shaping function according to the method 400 is now described below in detail. Essentially, the method 400 described above performs the following operations. The method 400 selects a fixed-distance HRTF-A (i.e., the first HRTF described above). HRTF-A may be a generic or a personalized HRTF. The method 400 selects a fixed-distance HRTFs based on a reasonable assumption that a sound source from the content application generates wavefronts that are planar with respect to the user within a fixed-distance range of the user. If the distance is lesser, special functions need to be used to model the wavefronts because the wavefronts are spherical and not planar if the distance is lesser. The method 400 processes the selected HRTF-A as follows.

The method 400 applies a shaping transformation (example equations are described below) to HRTF-A to reduce the strength of the HRTF-A in the front of the user and to gradually increase the strength of the HRTF-A to a 100% strength behind the user's head. The method 400 applies the shaping transformation as described above with reference to FIG. 7. The shaping transformation yields HRTF-B (i.e., the second HRTF described above).

The method 400 applies a further correction to HRTF-B to ensure that audio output of the content using the HRTF-B sounds acoustically pleasing to the user and provides an immersive experience to the user. For example, the method 400 applies the correction as an equalizer or as a filter. The equalizer is a function that normalizes the shaped HRTF (HRTF-B) to make the audio output of the content sound better and more even across all frequencies and all around the user's head. For example, the shaping transformation (i.e., conversion of HRTF-A to HRTF-B) leaves some marks or nonuniformities on the shaped HRTF (HRTF-B). The equalizer smoothens out the nonuniformities in HRTF-B, adjusts the volume (loudness of amplitude) of the shaped HRTF (HRTF-B), fine-tunes HRTF-B so that the audio output of the content sounds crisp, etc. The correction yields HRTF-C (i.e., the shaped HRTF).

The method 400 repeats the above procedure for all the points on the grid with the shaping function's functionality changing based on the location of the point on the grid. The final HRTF-C (i.e., the shaped HRTF) can be used as is or can be written to a file in a library. The user can select the file (i.e., the shaped HRTF) from the library when consuming the content.

The strength scaling (i.e., shaping) of the input HRTF using example equations is described below. It should be noted that many other shaping methods may be used depending on changes in the equations or their parameters. For each point on the grid of a selected input HRTF (generic or personalized), the method 400 performs the following operations.

Based on the (azimuth, elevation, distance) combination of the selected point on the grid, the method 400 determines a strength scaling parameter ‘r’. For example, the strength scaling parameter ‘r’ may be determined using equation 1A or 1B shown below. The terms used in the equations below are described after explaining the use of the equations.

r=1−cos(scaled_distance×\sqrt{theta²+phi²}×pi÷180) (Eq. 1A)

r=(curve_scale÷(1+exp(tightness×(scaled_distance×\sqrt{theta²+phi²}−angle_offset)÷180)))−curve_offset (Eq.1B)

Based on strength scaling parameter ‘r’, the method 400 determines a strength scaling factor ‘strength_scale’ that determines the amount of the output HRTF's strength based on equation 2 shown below.

strength_scale=strength_scale_m*r+strength_scale_c (Eq. 2)

The strength scaling factor ‘strength_scale’ is applied as a function of the input HRTF. Based on the input HRTF, the strength of the input HRTF is reduced by determining an averaging filter of size ‘strength_scale’ and by moving the averaging filter across the input HRTF based on equation 3 shown below.

strength_scaled_hrtf_fft=convolve(hrtf_fft,ones(shape=(int(rounded_strength_scale))),‘valid’)/rounded_strength_scale (Eq. 3)

The strength scaling parameter from equation 1A/1B feeds into equation 2 to form the strength scaling factor. Equations 1 (1A or 1B), 2, and 3 together form the strength scaling (shaping) function. Equations 1A and 1B are only two examples of equation 1. Equations 1A and 1B can be used in different circumstances (e.g., depending on content type). For example, Eq. 1A may be better suited for first person shooter (FPS) games while Eq. 1B may be better suited for massively multiplayer online role-playing game (MMORPG) third person games. Other equations may be used depending on the content type.

Note that the shaping function is determined based on factors such as content type, position of the sound object, head position, etc. While these parameters are not directly used in the above equations, the parameters that get fed into these equations take these factors into account. Thus, the factors such as content type, sound object position, head position, etc. are indirectly used in the above equations.

The terms used in these equations are now described below.

r—the strength scaling parameter that feeds into the strength scaling function.

scaled_distance—relative distance of the sound field from the user's head.

theta, phi—location of sound source on the HRTF grid.

curve_scale—determines the minimum and maximum amplitudes of the shaping function.

tightness—determines the transition from low strength to high strength HRTF.

angle_offset—determines the location of transition effect characterized by tightness.

strength_scale—amount of shaping the HRTF will undergo at a selected point depending on ‘r’.

strength_scale_m—slope of the line that governs the shaping function (note that Eq. 2 is of the form y=mx+c).

strength_scale_c—they intercept of the line that governs the shaping function.

strength_scaled_hrtf_fft—output HRTF (HRTF-B) after application of the strength scaling functions.

convolve—convolution operator.

hrtf_fft—input HRTF of which the strength is being scaled.

rounded_strength_scale—rounded value of the strength scale from equation 2.

Before describing the terms “ones” and “valid” used in Eq. 3, the averaging filter referenced above is explained. For example, Eq. 2 may yield a result N, where N is an integer greater than 1. For example, N can be between 2 and 99, or any integer greater than 1. An averaging filter size of N comprising all 1/N (a fraction less than 1) valued elements is constructed. The averaging function is then swept across the input HRTF (HRTF-A) in a convolutional manner according to Eq. 3. The convolution is performed in frequency domain (not in time domain) to average out the finer details of the HRTF being shaped (HRTF-A). The averaging power is proportional to the size of the averaging filter size. The averaging filter is moved in 3D space (the grid), and the strength of the averaging filter changes depending on the location (i.e., the selected point on the grid) where the averaging filter is applied in the 3D space.

Moreover, the averaging filter is moved in the frequency domain which yields the strength scaled (shaped) HRTF. Stating in terms of the above equations, moving the averaging filter involves repeating the application of Eq. 2 to the input HRTF (HRTF-A) at each point on the grid in frequency domain; and the results obtained in each iteration, when combined, yields HRTF-B, which is mathematically denoted by Eq. 3. That is, the application of Eq. 2 to the entire grid in frequency domain works as a moving average filter, and the whole shaping operation is denoted by Eq. 3.

Based on the above explanation of the averaging filter, the term “ones” in Eq. 3 indicates creating an array of all ‘ones’ (see constructing an “averaging filter size of N comprising all 1/N valued elements” described above), divided by the rounded strength scaling factor. Valid is a term used in convolution operations where the central portion of the result is used and the vestigial portion is disregarded.

The shaping function accentuates frontal versus rear HRTF response to make the audiovisual content more aurally-visually relatable to the user. More spatialization is needed in the rear than in front of the user because the user relies more on sounds coming in from behind the user since the user cannot see what is behind the user (from ear to back of the user's head). When the user rotates while consuming the content, the shaped sound field (due to the shaped HRTF) rotates with the user, and now what was in the front becomes the user's rear and vice-versa. Equations 1-3 make the rotation transition smooth.

The reshaping works well for all angles (see example graphs discussed below). The positions of 0 and 180 degrees (front and back of the user's head, respectively) are the two extremes. The method 400 covers all 360 degrees of space around the user in azimuth and elevation. The shaping operation of equations 1-3 in making the rotation transition smooth works for transitions to all positions in the 360 degrees of space around the user in azimuth and elevation.

Thus, the shaped HRTFs provide users a clearer front side (tone-wise) perception without loss of spatializing capability. This effect is achieved by shaping the HRTF's strength such that the minimum strength area is in the front of the subject. The strength of the shaped HRTF is gradually increased while moving into the peripheral visual field of the subject so that the subject's peripheral and blind vision spots are aided and augmented aurally by the spatializing quality of the shaped HRTF.

The shaped HRTFs provide significant improvements over personalized HRTFs in scenarios (e.g., video games) where tonal quality in the front is vital. The shaped HRTFs can be used in all applications where normal HRTFs can be used. The shaped HRTFs can be used more dominantly in applications that have a dynamic playing field (e.g., in an interactive game where the player can turn around). For applications with a static field, where the subject is stationary with respect to the content (e.g., a movie, or wherever there is no feedback mechanism), the shaped HRTFs can offer clearer tone in the front while maintaining a desired level of spatialization in the peripheral areas.

Note that for a user using a client device 104 to play different types of content (e.g., games, movies, etc.), the method 400 described above can create multiple shaped HRTFs for each content type, each sound object position, each type of headphone used to consume the content. Accordingly, for each user, the method 400 can create a library of HRTFs depending on combinations of these variables.

FIG. 8 shows a method 500 for generating libraries of shaped HRTFs according to the present disclosure. Again, the method 500 can be performed on the server 102, on the client device 104, or partly on each of the server 102 and the client device 104. For example, the method 500 can be implemented as the shaping application in the form of a program product. For example, the method 500 can be an extension of and integrated with the method 400.

At 502, the method 500 receives parameters including the graphical representation of the pinna, content type, sound object position, and headphone type (e.g., via the GUI described above). At 504, the method 500 elects one variable parameter (e.g., content type, sound object position, headphone type) with the pinna of the user being invariable parameters. At 506, the method 500 generates a shaped HRTF for a value of the selected variable parameter using the procedure described above with reference to method 400.

At 508, the method 500 determines if all values of the selected variable are exhausted (i.e., if a shaped HRTF is generated for all values of the selected variable). If not (i.e., if a shaped HRTF is not generated for all values of the selected variable), at 510, the method 500 selects a next value of the selected variable, and the method returns to 506. If yes (i.e., if a shaped HRTF is generated for all values of the selected variable), at 512, the method 500 determines if all variables are exhausted (i.e., if shaped HRTFs are generated for all the variables). If not (i.e., if shaped HRTFs are not generated for all the variables), at 514, the method 500 selects the next variable, and the method 500 returns to 504. If yes (i.e., if shaped HRTFs are generated for all the variables), at 516, the method 500 stores the shaped HRTFs generated in step 506 in a library for the user.

Additionally, the method 400 can further enhance the immersion experience of the user by dynamically changing the equalization (EQ) of the headphones based on the headphone type. For example, the shaping application on the client device 104 can include functionality to dynamically change the equalization (EQ) of the headphones based on the type of headphone used to consume the content. Just like a speaker, every headphone has a unique frequency response. Due to headphone-ear coupling, no headphone is acoustically transparent and thus modifies the incoming frequency response. Headphone responses can be empirically measured. Once the headphone responses are obtained, the headphone equalization (EQ) is measured by taking inverse of this response.

However, performing just headphone equalization would create a flat headphone response, which often does not result in a good listening experience. Starting with the inverse response as a reference, acoustical tuning is performed using listening experiments in order to obtain the final headphone EQ. For best listening experience, headphone EQs can also be personalized as EQ depends on the headphone-ear coupling which varies from individual to individual. This functionality is included in the shaping application on the client device 104 to further augment the shaped and equalized HRTF.

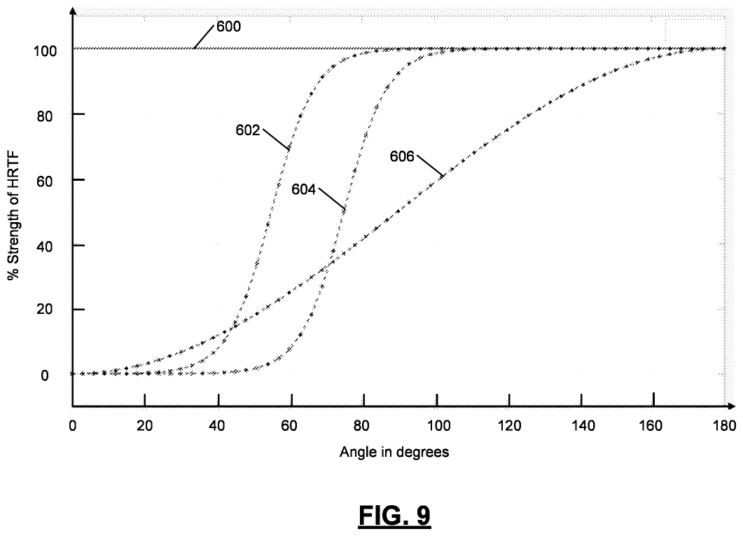

FIGS. 9-20 show various graphs illustrating examples of the shaped HRTFs. Specifically, these figures show the strengths of a shaped HRTF at different angles relative to the user's head, with zero degrees being front center of the user's head, 90 degrees being along the user's ears (e.g., along a line joining the user's ears), and 180 degrees being back center of the user's head.

FIG. 9 shows a graph of examples of unshaped and shaped HRTFs plotted with % strength of HRTF on the Y axis and angle in degrees on the X axis. A generic HRTF is shown at 600. Note the flat (constant or uniform) strength of the generic HRTF at all angles. Three examples of shaped HRTFs are shown at 602, 604, and 606. A shaped HRTF generated using Eq. 1A is shown at 606. Examples of shaped HRTFs generated using Eq. 1B are shown at 604 and 602. Left and right sides of users' heads are generally symmetrical. Therefore, assuming the symmetry, representation of one side (0-180 degrees) is sufficient.

In contrast to the uniform strength of the unshaped HRTF shown at 600, in the shaped HRTFs shown at 602, 604, and 606, note the low strength of the shaped HRTF in front center (at and near zero degrees), high strength of the shaped HRTF as the angle increases towards the sides of the ears (about 60-100 degrees), and high strength of the shaped HRTF near and beyond the sides of the ears (about 100-180 degrees). Again, left and right sides are symmetrical; and therefore, representation of one side (0-180 degrees) is sufficient.

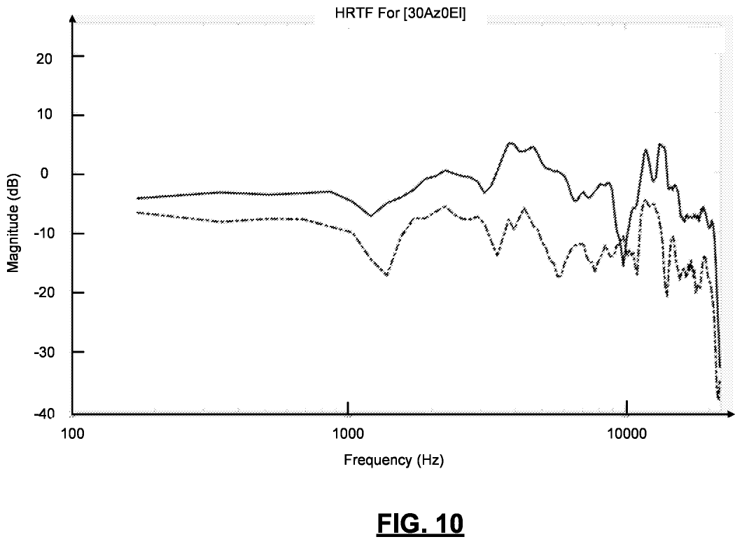

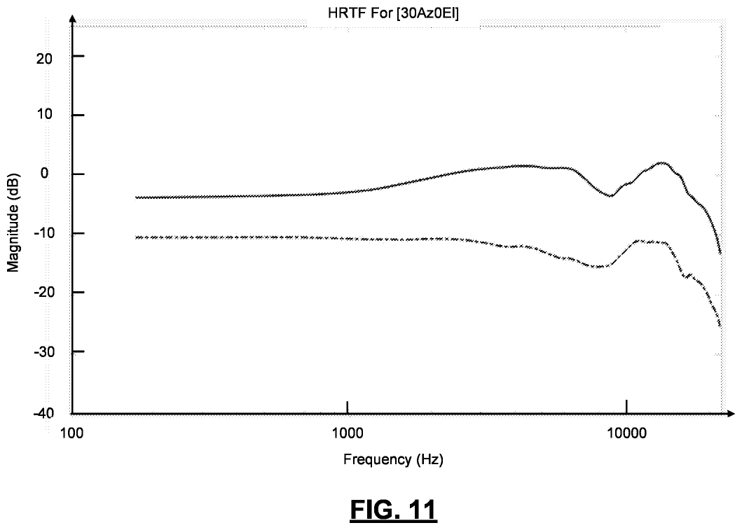

FIGS. 10-14 show graphs of unshaped and shaped HRTFs at a selected angle, with shaped HRTFs generated using different strengths of the shaping function. FIG. 10 shows an unshaped HRTF. FIGS. 11-14 show shaped HRTFs. In these graphs, the magnitude of the HRTF in decibels (dB) is plotted on the Y axis, and frequency of audio component of the content consumed using the HRTFs is plotted on the X axis. In these graphs, solid lines represent left channel of the audio component, and dashed lines represent right channel of the audio component.

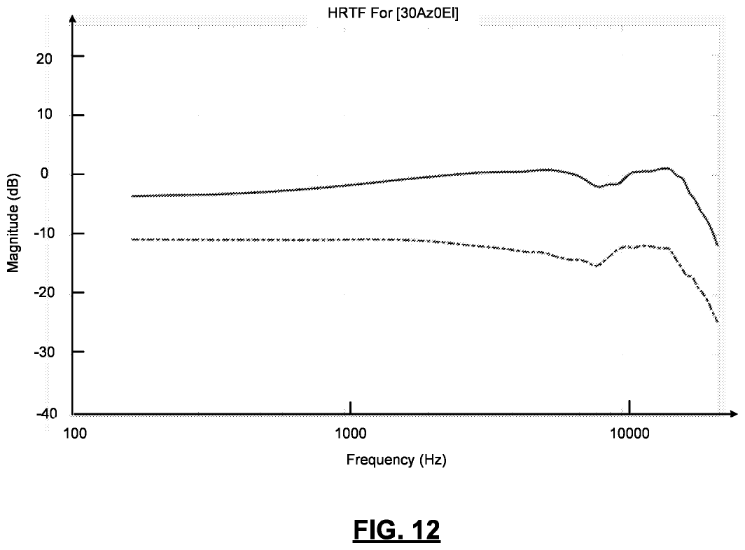

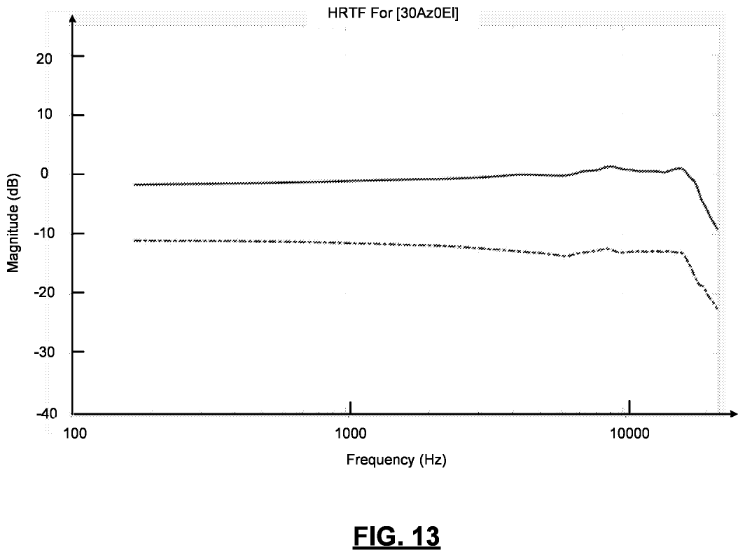

FIG. 10 shows a graph for an unshaped HRTF at 30 degrees azimuth and 0 degrees elevation, which is denoted using notation (30,0), at 100% strength. The same notation for indicating azimuth and elevation is used in the following description for brevity. FIG. 11 shows a graph for a shaped HRTF at (30,0) at 78% strength relative to the unshaped HRTF. FIG. 12 shows a graph for a shaped HRTF at (30,0) at 67% strength relative to the unshaped HRTF. FIG. 13 shows a graph for a shaped HRTF at (30,0) at 45% strength relative to the unshaped HRTF. FIG. 14 shows a graph for a shaped HRTF at (30,0) at 12% strength relative to the unshaped HRTF.

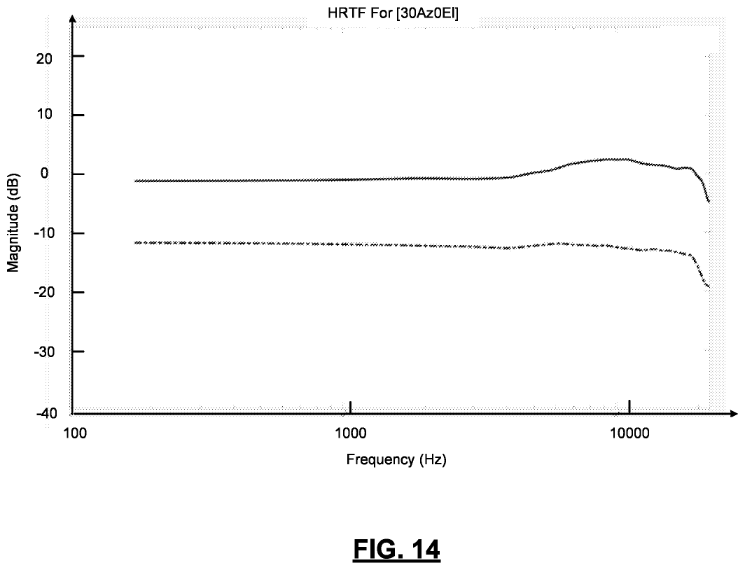

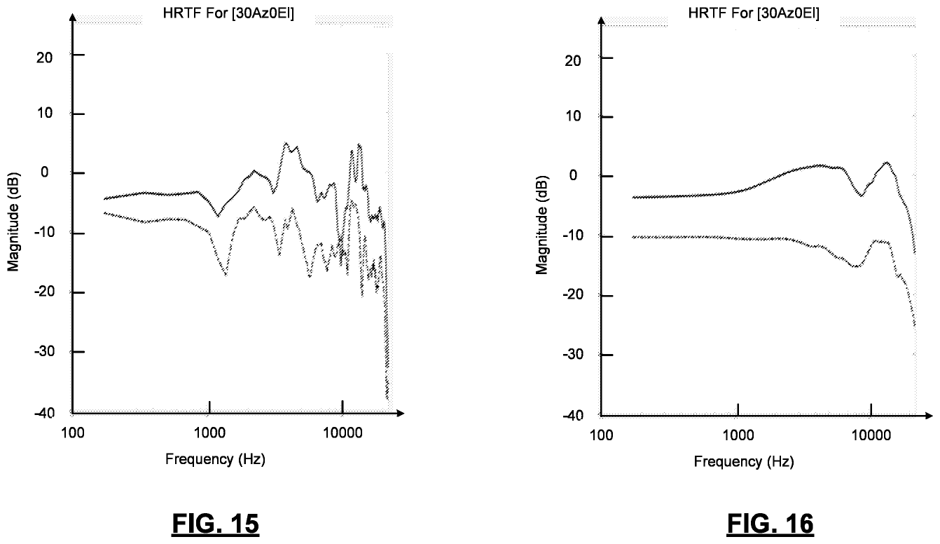

FIGS. 15-20 show graphs of unshaped and shaped HRTFs at different angles and varying strength of the shaping function. FIGS. 15, 17, and 19 show unshaped HRTFs. FIGS. 16, 18, and 20 show shaped HRTFs. For example, the shaped HRTFs shown in FIGS. 16, 18, and 20 are generated using Eq. 1A, although other equations can be used instead. In these graphs, the magnitude of the HRTF in decibels (dB) is plotted on the Y axis, and frequency of audio component of the content consumed using the HRTFs is plotted on the X axis. In these graphs, solid lines represent left channel of the audio component, and dashed lines represent right channel of the audio component.

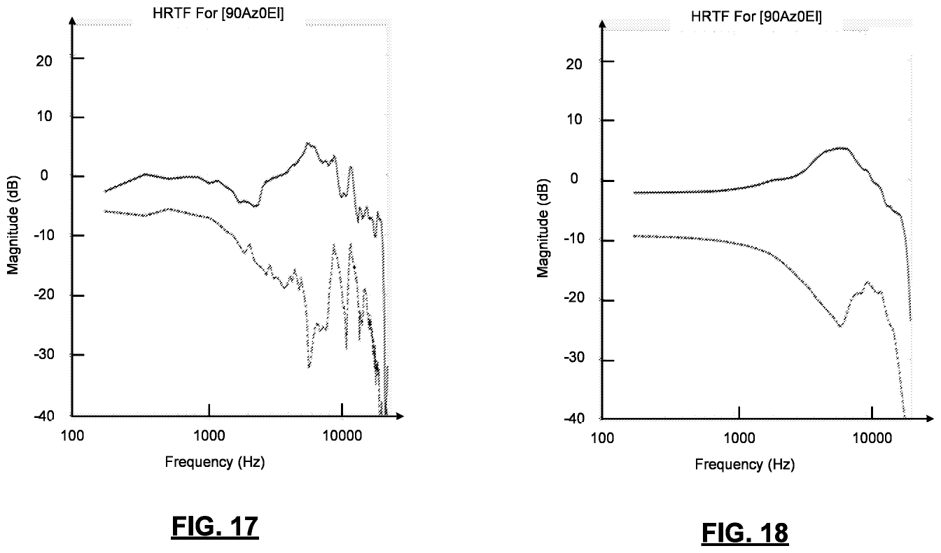

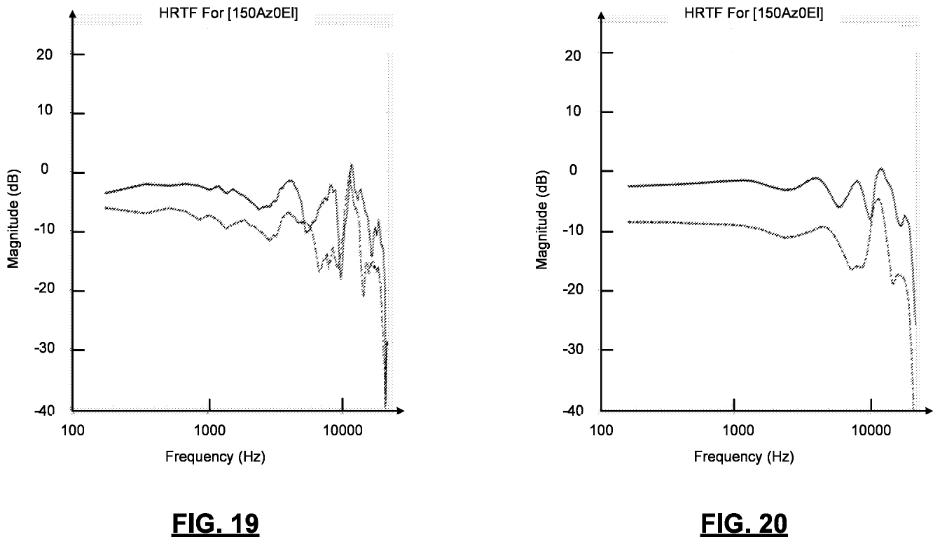

FIGS. 15 and 16 respectively show unshaped and shaped HRTFs at (30,0) at 8% strength. FIGS. 17 and 18 respectively show unshaped and shaped HRTFs at (90,0) at 50% strength. FIGS. 19 and 20 respectively show unshaped and shaped HRTFs at (150,0) at 90% strength.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between controllers, processors, circuit elements, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “controller” or the term “processor” may be replaced with the term “circuit.” The term “controller” or the term “processor” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The controller may include one or more interface circuits. In some examples, the interface circuits may include wired or wireless interfaces that are connected to a local area network (LAN), the Internet, a wide area network (WAN), or combinations thereof. The functionality of the controller or the processor of the present disclosure may be distributed among multiple controllers or processors that are connected via interface circuits. For example, multiple controllers or processors may allow load balancing.

The term code or computer program product, as used above, may include software, firmware, and/or microcode, and may refer to programs, routines, functions, classes, data structures, and/or objects. The term shared processor circuit encompasses a single processor circuit that executes some or all code from multiple controllers or processors. The term group processor circuit encompasses a processor circuit that, in combination with additional processor circuits, executes some or all code from one or more controllers or processors. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple controllers or processors. The term group memory circuit encompasses a memory circuit that, in combination with additional memories, stores some or all code from one or more controllers or processors.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A method comprising:
receiving an input head-related transfer function (HRTF); and
applying a shaping function to the input HRTF to generate a shaped HRTF having a minimum strength at a first point in a three-dimensional space, a maximum strength at a second point in the three-dimensional space, and a gradually increasing strength between the first point and the second point in the three-dimensional space.

2. The method of claim 1 further comprising:
processing audio component of an audiovisual application using the shaped HRTF; and
outputting the processed audio component of the audiovisual application via an output device.

3. The method of claim 2 further comprising aurally augmenting visual sensory cues associated with the audiovisual application based on the gradually increasing strength of the shaped HRTF between the first point and the second point in the three-dimensional space.

4. The method of claim 1 wherein the shaped HRTF is configured to provide accurate spatial perception throughout the three-dimensional space while providing accurate tonal perception at the first point in the three-dimensional space when audio component of an audiovisual application is output through an output device using the shaped HRTF.

5. The method of claim 1 further comprising generating the shaping function based on at least one of a type of audiovisual content with which the shaped HRTF is to be used, a position of each sound object associated with the audiovisual content, and a type of headphone through which audio component of the audiovisual content is to be output.

6. The method of claim 1 further comprising controlling parameters of the shaping function to control a gradient of the gradually increasing strength of the shaped HRTF between the first point and the second point in the three-dimensional space.

7. The method of claim 1 further comprising controlling parameters of the shaping function based on at least one of a type of audiovisual content with which the shaped HRTF is to be used, a position of each sound object associated with the audiovisual content, and a type of headphone through which audio component of the audiovisual content is to be output.

8. The method of claim 1 further comprising applying an equalizer function to the shaped HRTF to smooth the shaped HRTF and to match loudness between the shaped HRTF and the input HRTF.

9. The method of claim 1 further comprising changing equalization of a headphone through which audio component of an audiovisual content is to be output using the shaped HRTF.

10. The method of claim 1 wherein the input HRTF is a generic HRTF.

11. The method of claim 1 further comprising:
receiving a graphical representation of a pinna including an image or images, a video, or a 3D scan of the pinna; and
generating the input HRTF based on the graphical representation of the pinna.

12. A system comprising:
a processor; and
memory storing instructions which when executed by the processor cause the processor to:
provide an audiovisual content through a display and an audio output device;
select a shaped head-related transfer function (HRTF) based on a type of the audiovisual content;
process audio component of the audiovisual content using the selected shaped HRTF; and
output the processed audio component through the audio output device,
wherein the selected shaped HRTF is configured to provide accurate spatial perception throughout a three-dimensional space surrounding a listener of the processed audio component while providing accurate tonal perception in front of the listener in the three-dimensional space.

13. The system of claim 12 wherein the shaped HRTF has a minimum strength in front of the listener in the three-dimensional space, a maximum strength at the back of the listener in the three-dimensional space, and a gradually increasing strength between the front and the back of the listener in the three-dimensional space.

14. The system of claim 12 wherein the shaped HRTF aurally augments visual sensory cues associated with the audiovisual content based on a gradually increasing strength of the shaped HRTF between the front and the back of the listener in the three-dimensional space.

15. The system of claim 12 wherein the shaped HRTF is smoothed by applying an equalizer function to the shaped HRTF.

16. The system of claim 12 wherein the instructions cause the processor to change equalization of the audio output device.

17. The system of claim 12 wherein the instructions cause the processor to generate the shaped HRTF by applying a shaping function to an input HRTF, wherein parameters of the shaping function are controlled to control a gradient of strength of the shaped HRTF between the front and the back of the listener in the three-dimensional space.

18. The system of claim 17 wherein the instructions cause the processor to control the parameters of the shaping function based on at least one of the type of the audiovisual content, a position of the audio output device, and a type of the audio output device.

19. The system of claim 17 wherein the instructions cause the processor to apply an equalizer function to the shaped HRTF to smooth the shaped HRTF and to match loudness between the shaped HRTF and the input HRTF.

20. The system of claim 17 wherein the input HRTF is a generic HRTF.

21. The system of claim 17 wherein the instructions cause the processor to:
receive a graphical representation of a pinna of the listener including an image or images, a video, or a 3D scan of the pinna; and
generate the input HRTF based on the graphical representation of the pinna of the listener.

22. The system of claim 17 wherein the instructions cause the processor to:
send a graphical representation of a pinna of the listener to a remote server, the graphical representation including an image or images, a video, or a 3D scan of the pinna; and
receive from the remote server the input HRTF generated by the remote server based on the graphical representation of the pinna of the listener.

23. The system of claim 12 wherein the instructions cause the processor to:
send a graphical representation of a pinna of the listener to a remote server, the graphical representation including an image or images, a video, or a 3D scan of the pinna; and
receive the shaped HRTF from the remote server.

24. The system of claim 23 wherein the instructions cause the processor to:
send the type of the audiovisual content to the remote server; and
receive from the remote server the shaped HRTF generated by the remote server based on the type of the audiovisual content.

25. The system of claim 12 wherein the instructions cause the processor to:
provide a graphical user interface (GUI) on the display;
receive a plurality of shaped HRTFs from a remote server;
receive inputs from the listener via the GUI, the inputs including at least one of the type of the audiovisual content, a position of the audio output device, and a type of the audio output device; and
select the shaped HRTF from the plurality of shaped HRTFs based on the inputs.

26-59. (canceled)
